(19) United States
(12) Patent Application Publication
(10) Pub. No.: US 2025/0053738 A1
(43) Pub. Date: Feb. 13, 2025

(54) AUTOMATED TEXT-TO-SPEECH PRONUNCIATION EDITING FOR LONG FORM TEXT DOCUMENTS

(71) Applicant: Google LLC, Mountain View, CA (US)

(72) Inventors: Ryan Dingler, Mill Valley, CA (US); John Rivlin, Palo Alto, CA (US); Christopher Salvarani, Mountain View, CA (US); Yuanlei Zhang, Milpitas, CA (US); Nazarii Kukhar, Santa Clara, CA (US); Russell John Wyatt Skerry-Ryan, Mountain View, CA (US); Daisy Stanton, San Francisco, CA (US); Judy Chang, Saratoga, CA (US); Md Enzam Hossain, Mountain View, CA (US)

(21) Appl. No.: 18/720,376

(22) PCT Filed: Dec. 20, 2021
(86) PCT No.: PCT/US2021/073030

§ 371 Date: Jun. 14, 2024

(51) Int. Cl. G06F 40/253; G06F 3/0484; G06F 3/16; G06F 40/169; G06F 40/289; G10L 13/08

(52) U.S. Cl. CPC G06F 40/253; G06F 3/165; G06F 40/169; G06F 40/289; G10L 13/08; G06F 3/0484

(57) ABSTRACT

Aspects of this disclosure are directed to techniques that enable efficient automated text-to-speech pronunciation editing for long form text documents. A computing device comprising a memory and a processor may be configured to perform the techniques. The memory may store a text document. The processor may process words in the text document to identify first candidate words that are predicted to be mispronounced during automated text-to-speech processing of the text document. The processor may next filter the first candidate words to remove one or more candidate words of the first candidate words and obtain second candidate words that have fewer candidate words than the first candidate words. The processor may then annotate the text document to obtain an annotated text document that identifies the second candidate words, and output at least a portion of the annotated text document that identifies at least one candidate word of the second candidate words.

### BACKGROUND

There are millions of long form text documents, such as books, manuals, research papers, and the like, that have been published for public consumption. Consumers of certain long form text genres, such as, for example, self-help, business, history, biography, health, and religion, may desire a narrated version of the long form text document, where the narrated version of the long form text document may be referred to as an audio book. However, while there is demand for audio books (particularly, in the above noted long form text genres), generation of the audio books can be prohibitively expensive unless the long form text document is successful (in terms of unit sales). For example, generation of a given audio book may require hiring of an often expensive voice actor (or, in other words, a narrator) and require many hours for the narrator to correctly read aloud the long form text documents in a studio setting (where hourly rates are generally costly, possibly exceeding $100 an hour).

As such, many authors choose to rely on automated text-to-speech algorithms that utilize a narration model to read aloud the text of the long form text document. While automated text-to-speech algorithms may provide a quick alternative to human narration that facilitates replication of an audio book experience (possibly in near real-time, meaning such automated text-to-speech algorithms reside on a reader's device to offer this audio book experience), the automated text-to-speech algorithms may mispronounce words that would otherwise be correctly narrated by a human narrator. To overcome these mispronunciations, the author (or other editor) may edit the underlying long form text document to reduce mispronunciation by the automated text-to-speech algorithm that then degrades the author's intent when the reader attempts to read the text version of the long form text document.

### SUMMARY

The disclosure describes various aspects of techniques that enable efficient automated text-to-speech pronunciation editing for long form text documents. The pronunciation editing may resemble a spell check (and hence may be referred to as pronunciation checking) provided in text editors (which are also referred to as word processors). A computing device may receive a long form text document and perform the pronunciation editing to identify candidate words that are likely to be mispronounced during automated text-to-speech processing. However, rather than provide all candidate words for consideration by an editor, the computing device may filter the candidate words in various ways to reduce the number of candidate words to a more manageable number (e.g., some threshold number of candidate words).

Filtering of candidate words may reduce time spent on inconsequential mispronunciations and focus attention on difficult to pronounce words (e.g., proper nouns, vague words in terms of, as an example, inflection, etc.), intentionally misspelled words. words with the same spelling but different pronunciations (which are referred to as homographs), and the like. As such, editors may focus on candidate words that are likely to significantly detract from the audio experience. In some instances, the editor may interact with the computing device to enter a verbal pronunciation that the computing device then uses to correct the automated text-to-speech pronunciation (e.g., selecting a pronunciation that best matches the entered verbal pronunciations).

In this way, various aspects of the techniques may thereby facilitate more efficient execution of the computing device in terms of computing resources (e.g., processor cycles, memory usage, memory bus bandwidth usage, and the accompanying power consumption) while also promoting a better user experience for editing potential mispronunciations by automated text-to-speech algorithms. The techniques may reduce utilization of computing resources by filtering candidate words to enable editors to focus on words that are difficult to pronounce, which results in less processing during the editing process and thereby reduces utilization of the computing resources. Moreover, the techniques may provide a better editing experience by focusing attention on words that are difficult to pronounce while also improving pronunciation of candidate words by automated text-to-speech algorithms (which produces a better quality audio book experience compared to automated text-to-speech algorithms that do not facilitate pronunciation review and adjustment).

In one example, various aspects of the techniques are directed to a method comprising: processing words in a text document to identify a first plurality of candidate words that are predicted to be mispronounced during automated text-to-speech processing of the text document; filtering the first plurality of candidate words to remove one or more candidate words of the first plurality of candidate words and obtain a second plurality of candidate words that have fewer candidate words than the first plurality of candidate words: annotating the text document to obtain an annotated text document that identifies the second plurality of candidate words; and outputting at least a portion of the annotated text document that identifies at least one candidate word of the second plurality of candidate words.

In another example, various aspects of the techniques are directed to a computing device comprising: a memory configured to store a text document, one or more processors configured to: process words in the text document to identify a first plurality of candidate words that are predicted to be mispronounced during automated text-to-speech processing of the text document; filter the first plurality of candidate words to remove one or more candidate words of the first plurality of candidate words and obtain a second plurality of candidate words that have fewer candidate words than the first plurality of candidate words; annotate the text document to obtain an annotated text document that identifies the second plurality of candidate words; and output at least a portion of the annotated text document that identifies at least one candidate word of the second plurality of candidate words.

In another example, various aspects of the techniques are directed to a non-transitory computer-readable storage medium having instructions stored thereon that, when executed, cause one or more processors to: process words in a text document to identify a first plurality of candidate words that are predicted to be mispronounced during automated text-to-speech processing of the text document; filter the first plurality of candidate words to remove one or more candidate words of the first plurality of candidate words and obtain a second plurality of candidate words that have fewer candidate words than the first plurality of candidate words; annotate the text document to obtain an annotated text document that identifies the second plurality of candidate words; and output at least a portion of the annotated text document that identifies at least one candidate word of the second plurality of candidate words.

In another example, various aspects of the techniques are directed to an apparatus comprising: means for processing words in a text document to identify a first plurality of candidate words that are predicted to be mispronounced during automated text-to-speech processing of the text document; means for filtering the first plurality of candidate words to remove one or more candidate words of the first plurality of candidate words and obtain a second plurality of candidate words that have fewer candidate words than the first plurality of candidate words; means for annotating the text document to obtain an annotated text document that identifies the second plurality of candidate words; and means for outputting at least a portion of the annotated text document that identifies at least one candidate word of the second plurality of candidate words.

### BRIEF DESCRIPTION OF DRAWINGS

FIG. 1 is a diagram illustrating an example computing device configured to perform pronunciation editing for automated text-to-speech algorithms in accordance with one or more aspects of the present disclosure.

FIGS. 2A-2C are diagrams illustrating example user interfaces with which a human editor may interact to facilitate efficient pronunciation checking for long form text documents in accordance with various aspects of the techniques described in this disclosure.

FIGS. 3A-3C are additional diagrams illustrating example user interfaces with which the human editor may interact to facilitate efficient pronunciation checking for long form text documents in accordance with various aspects of the techniques described in this disclosure.

FIG. 4 is a flowchart illustrating example operation of an example computing device configured to perform pronunciation editing for automated text-to-speech algorithms in accordance with one or more aspects of the present disclosure.

### DETAILED DESCRIPTION

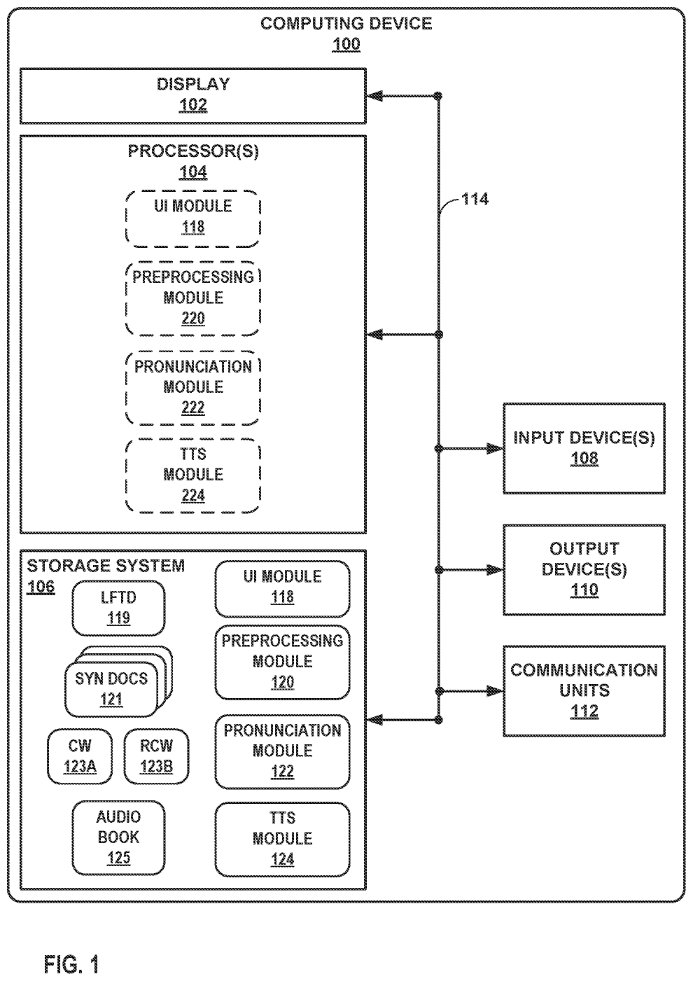

FIG. 1 is a diagram illustrating an example computing device configured to perform pronunciation editing for automated text-to-speech algorithms in accordance with one or more aspects of the present disclosure. Computing device 100 may represent any type of computing device capable of performing automated text-to-speech processing with respect to long form text documents. Examples of computing device 100 may include a desktop computer, a laptop computer, a cellular handset (including a so-called smartphone), a workstation, a server, a gaming console, a personal reading device (such as a dedicated e-book reader), and the like.

While described with respect to a single computing device 100, functions described herein as performed by computing device 100 may be performed by one or more computing devices. That is, computing device 100 may represent a distributed computing system (e.g., a so-called cloud computing system) in which, as an example, a server may perform some aspects of the techniques described herein to generate a user interface that the server hosts for access via a network (e.g., a public network such as the Internet). A client computing device may receive, in this example, the user interface (e.g., via a web browser) and enter input via the user interface in order to interact with the server. As such, various aspects of the techniques should not be limited to a single computing device 100 but may apply across various computing devices (e.g., the server and client device, multiple servers may host different aspects of the techniques, etc.).

In the example of FIG. 1, computing device 100 includes a display 102, processor(s) 104, a storage system 106, input device(s) 108, output device(s) 110, and communication units 112. Computing device 100 may include a subset of the components included in example computing device 100 or may include additional components not shown in FIG. 1 for ease of illustration purposes.

In any event, display 102 represents any type of display capable as acting as an output for visual presentation of data. Examples of display 102 include a liquid crystal display (LCD), dot matrix display, light emitting diode (LED) display, miniLED display, microLED display, organic LED (OLED) display, e-ink, or similar monochrome or color display capable of outputting visible information to a user of computing device 100. In this respect, display 102 may represent one example of output devices 110.

In some examples, display 102 may represent a presence-sensitive display (which may also be commonly referred to as a touchscreen, although this is a slight misnomer in that some presence-sensitive displays may sense inputs proximate to the presence-sensitive display without requiring physical contact) that is configured to operate as both an output and an input. The presence-sensitive display, in addition to functioning as an output, may also operate as an interface by which to receive inputs, such as selection of icons or other graphical user interface elements, entry of text, gestures (including multi-touch gestures), etc.

While illustrated as an internal component of computing device 100, display 102 may also represent an external component that shares a data path with computing device 100 for transmitting and/or receiving input and output. For instance, in one example, display 102 represents a built-in component of computing device 100 located within and physically connected to the external packaging of computing device 100 (e.g., a screen on a smartphone or an all-in-one computing device). In another example. display 102 represents an external component of computing device 200 located outside and physically separated from the packaging of computing device 100 (e.g., a monitor, a projector, etc., that shares a wired and/or wireless data path with a tablet computer).

Processors 104 may represent any type of processor capable of executing firmware, middleware, software or the like that is comprised of instructions that, when executed, cause processors 104 to perform operations described with respect to processor 104. Examples of processor 104 include a central processing unit (CPU), a graphics processing unit (GPU), a digital signal processor (DSP), a display processor, a field-programmable gate array (FPGA), a microprocessor, an application-specific integrated circuit (ASIC, such as an artificial intelligence accelerator ASIC), etc.

In some examples, processors 104 may include one or more cores that are integrated into a single so-called chip (meaning the one or more processing cores are packaged together and typically share memory, memory busses, registers, and/or other resources). The multiple cores may include cores dedicated to arithmetic, graphics processing, sensor processing, artificial intelligence processing (e.g., in the form of one or more ASICs), etc. While assumed to represent a SoC, processors 104 may represent any type of processor capable of executing instructions that facilitate implementation of various aspects of the techniques described herein.

Storage system 106 may store information for processing during operation of computing device 100 and represent an example of a computer-readable media. That is, in some examples, storage system 106 includes a temporary memory, meaning that a primary purpose of storage system 106 is not long-term storage. Storage system 106 of computing device 100 may be configured for short-term storage of information as volatile memory and therefore not retain stored contents if powered off. Examples of volatile memories include random access memories (RAM), dynamic random access memories (DRAM), static random access memories (SRAM), and other forms of volatile memories.

Storage system 106 may also, in some examples, include one or more computer-readable storage media, which may be configured to store larger amounts of information than volatile memory. Such computer-readable storage media may be non-transitory in nature, meaning that such data is maintained in the computer-readable storage media and is not transitory (e.g., not a transitory signal traveling a wire or other conductor). Storage system 106 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage system 106 may store program instructions and/or information (e.g., data) associated with modules 118-224 and related data, such as long form text document (LFTD) 119, synthesis documents (SYN DOCS) 121, and audio book 125.

One or more input devices 108 of computing device 100 may be configured to receive input. Input devices 108 of computing device 100, in one example, includes a presence-sensitive display (e.g., display 102), mouse, keyboard, video camera, microphone, physical buttons and/or switches (or other activators), ports (e.g., power ports, headphone ports, etc.), or any other type of device for detecting input from a human or machine. Input devices 108 may receive input data in the form of activation states (e.g., for buttons, switches, or any other physical interaction object), audio, images, sequences of images (which may refer to video), etc.

One or more output devices 110 of computing device 100 may be configured to generate output. Output devices 110 of computing device 100 may, in one example, includes a presence-sensitive display (e.g., display 102), an electronic rotating mass actuator (e.g., for producing haptic feedback), a sound card, a video graphics card, a speaker, a cathode ray tube (CRT) display, a liquid crystal display (LCD) display, a light emitting diode (LED) display, a microLED display, a miniLED display, an organic LED (OLED) display, a plasma display, or any other type of device for generating output to a human or machine. In some examples, display 102 may include functionality of input devices 108 (when, for example display 102 represents a presence-sensitive display) and/or output devices 110.

One or more communication units 112 of computing device 100 may be configured to communicate with external devices via one or more wired and/or wireless networks by transmitting and/or receiving network signals on the one or more networks. Examples of communication unit 112 include a network interface card (e.g., such as an Ethernet card), an optical transceiver, a radio frequency transceiver, a GPS receiver, or any other type of device that can send and/or receive information. Other examples of communication units 112 may include short wave radios, cellular data radios, wireless network radios, as well as universal serial bus (USB) controllers.

Communication channels 114 may interconnect each of the components 102-112 for inter-component communications (physically, communicatively, and/or operatively). In some examples, communication channels 114 may include a system bus, a network connection, an inter-process communication data structure, or any other method for communicating data.

As further shown in the example of FIG. 1, storage system 106 may store LFTD 119, which may represent a text document having an average number of words greater than 1,000 or even possibly 10,000 words. LFTD 119 may, as an example, represent a book (including an electronic book, which may be referred to as an e-book), a manual, a research paper, or the like. When LFTD 119 represents an e-book, the average number of words is typically greater than 40,000 words, as e-books range from 40,000 words to around 110,000 words. LFTD 119 may therefore be distinguished from short form text documents, such as text messages, electronic messages (including electronic mail, referred to as email), and the like in that LFTD 119 includes an average number of words at least one order of magnitude greater than the average number of words included in short form text documents.

Consumers of certain long form text genres, such as, for example, self-help, business, history, biography, health, and religion, may desire a narrated version of LFTD 119, where the narrated version of LFTD 119 may be referred to as an audio book. However, while there is demand for audio books (particularly, in the above noted long form text genres), generation of the audio books can be prohibitively expensive unless LFTD 119 is successful (in terms of unit sales). For example. generation of a given audio book may require hiring of an often expensive voice actor (or, in other words, a narrator) and require many hours for the narrator to correctly read aloud LFTD 119 in a studio setting (where hourly rates are generally costly, possibly exceeding $100 an hour).

As such, many authors choose to rely on automated text-to-speech algorithms that utilize a narration model to read aloud the text of LFTD 119. While automated text-to-speech algorithms may provide a quick alternative to human narration that facilitates replication of an audio book experience (possibly in near real-time, meaning such automated text-to-speech algorithms reside on a reader's device to offer this audio book experience), the automated text-to-speech algorithms may mispronounce words that would otherwise be correctly narrated by a human narrator. To overcome these mispronunciations, the author (or other editor) may edit the underlying LFTD 119 to reduce mispronunciation by the automated text-to-speech algorithm that then degrades the author's intent when the reader attempts to read the text version of LFTD 119.

In accordance with various aspects of the techniques described in this disclosure, computing device 100 may provide efficient automated text-to-speech pronunciation editing for LFTD 119. The pronunciation editing may resemble a spell check (and hence may be referred to as pronunciation checking) provided in text editors (which are also referred to as word processors). Computing device 100 may receive LFTD 119 (via a user interface) and perform the pronunciation editing to identify candidate words that are likely to be mispronounced during automated text-to-speech processing. However, rather than provide all candidate words for consideration by an editor, Computing device 100 may filter the candidate words in various ways to reduce the number of candidate words to a more manageable number (e.g., some threshold number of candidate words).

As shown in the example of FIG. 1, storage system 106 may store a user interface (UI) module 118, a preprocessing module 120, a pronunciation module 122, and a text-to-speech (TTS) module 124. As an initial matter, when operations are discussed as being performed by any one of modules 118-124, it should be understood that such modules 118-224, when executed, cause processors 104 to perform the operations described with respect to each of modules 118-124.

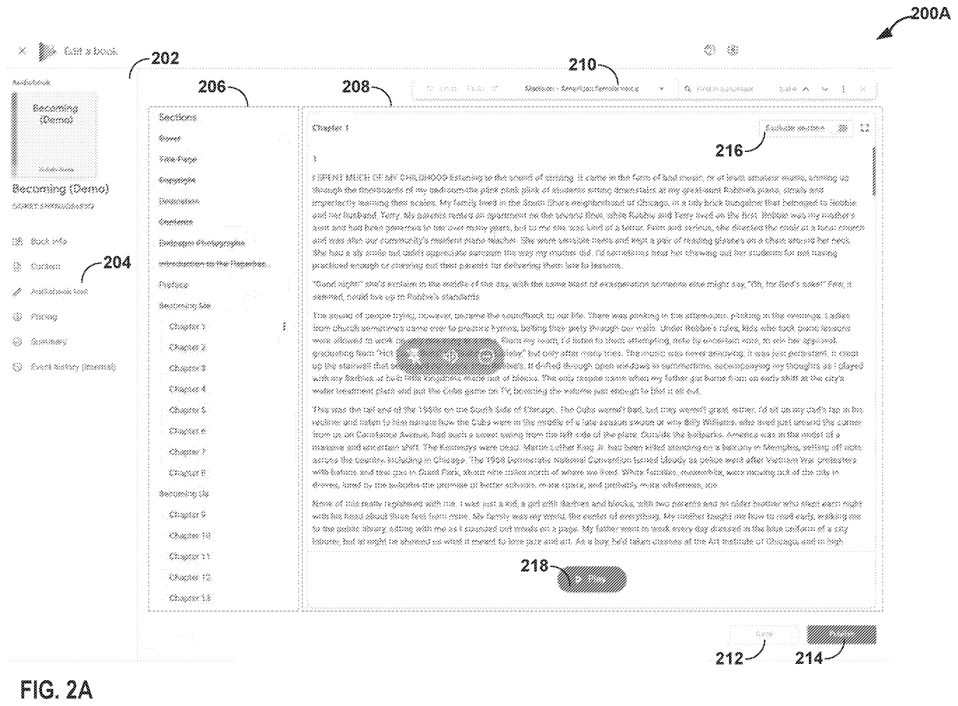

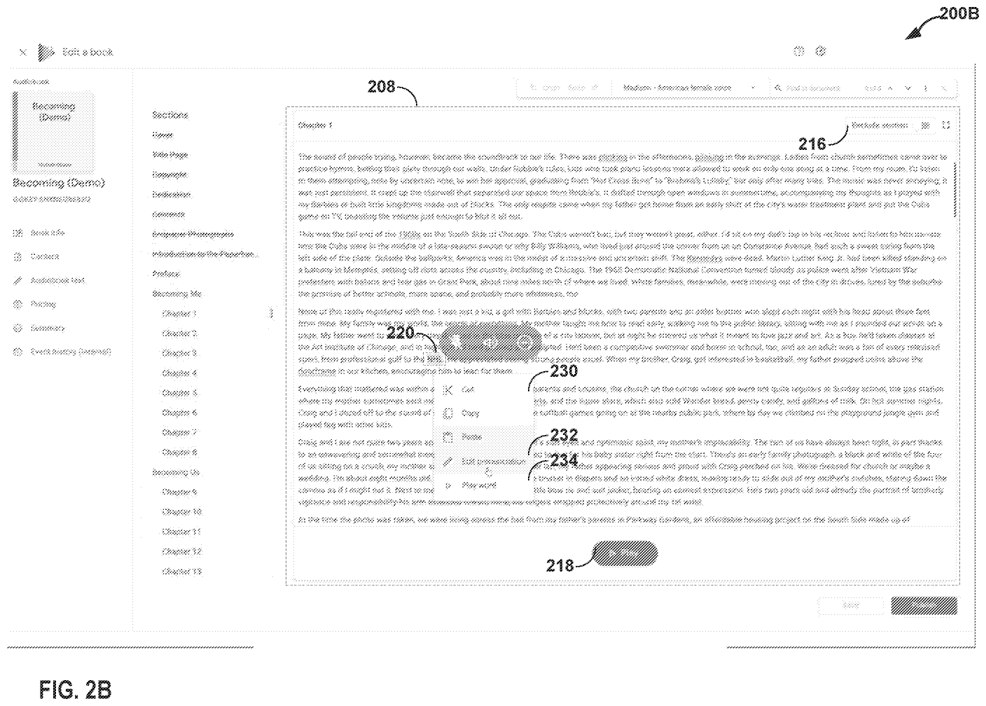

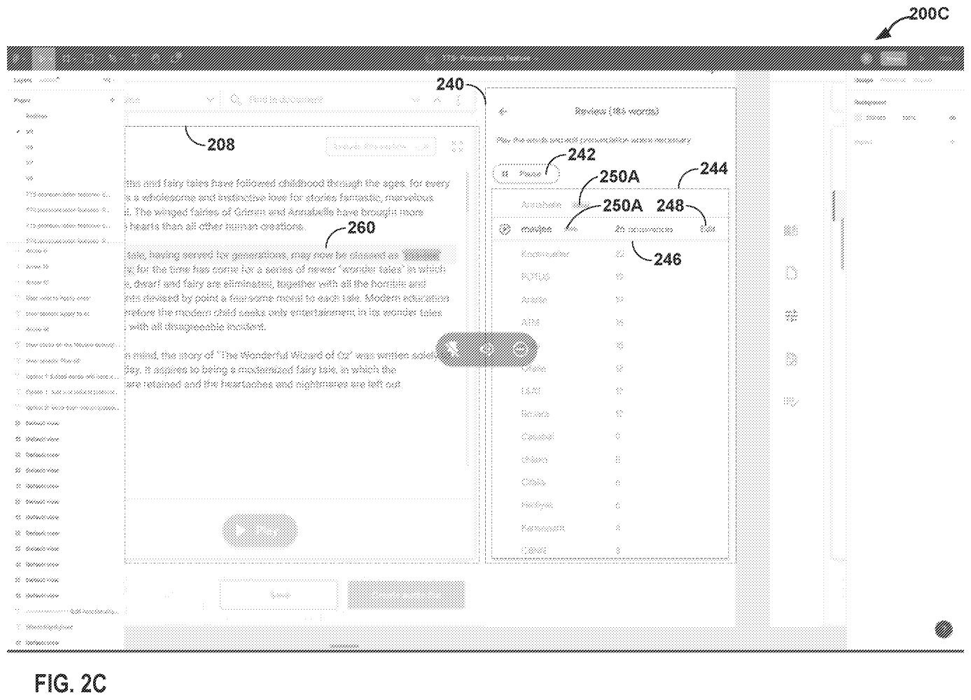

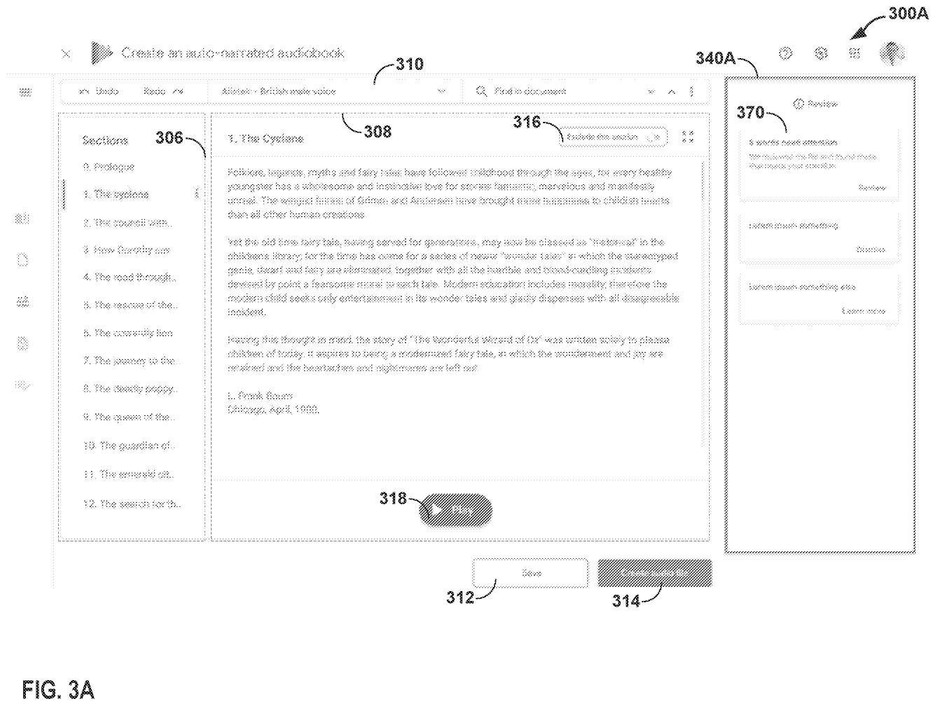

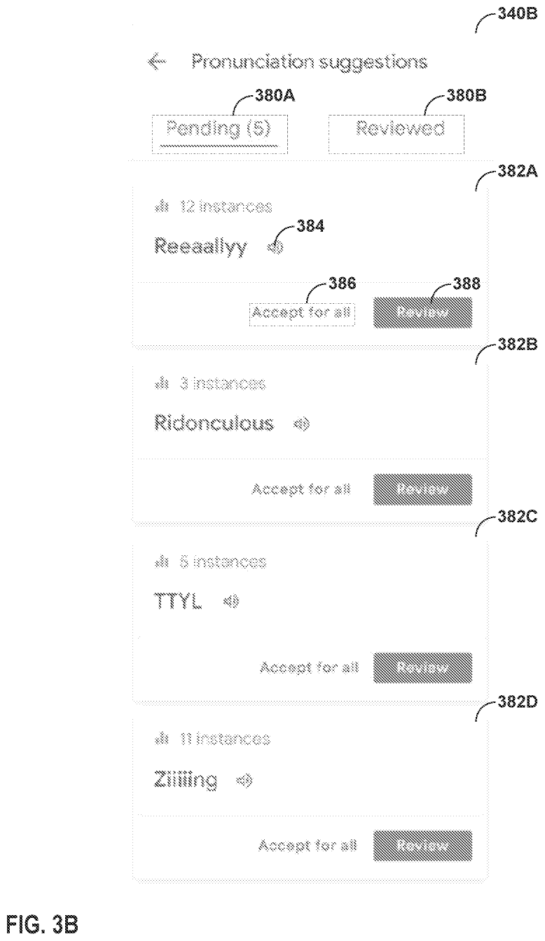

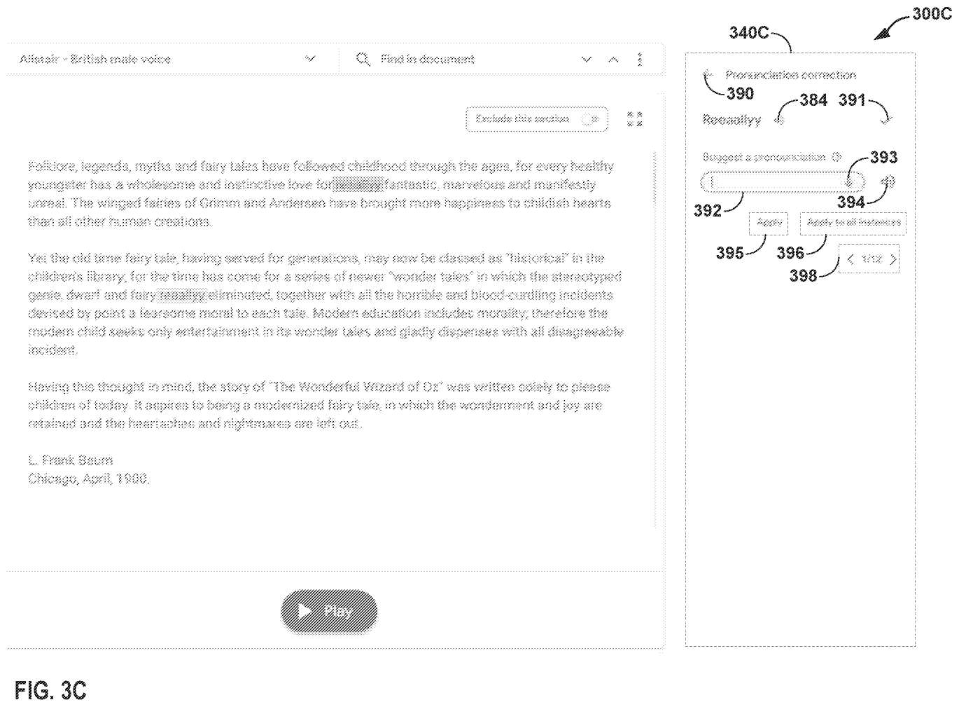

UI module 118 may represent instructions forming a module that, when executed, cause processors 104 to generate and present a UI with which a user (such as a human editor) may interact to receive output from computing device 100 and/or provide input to computing device 100. Example GUIs generated and output from UI module 118 are described in more detail below with respect to the examples of FIGS. 2A-3C.

Preprocessing modules 120 may represent instructions forming a module that, when executed, cause processors 104 to perform preprocessing with respect to LFTD 119. Preprocessing may refer to a process by which LFTD 119 is reformatted, divided, analyzed. synthesized, or otherwise processed in order to convert LFTD 119 into manageable data chunks (e.g., synthesized documents 121). Preprocessing may facilitate parallel (or, in other words, concurrent) processing of LFTD 219 to improve the efficiency (in terms of computing resources) of pronunciation checking LFTD 119 and generating audio book 125 from LFTD 119.

Pronunciation module 122 may represent instructions forming a module that, when executed, cause processors 104 to perform pronunciation checking with respect to synthesized documents 121 in order to obtain candidate words (CW) 123A. Pronunciation module 122 may also include instructions that, when executed, cause processors 104 to perform filtering of CW 123A in order to remove one or more candidate words from CW 123A and thereby generate remaining candidate words (RCW) 123B.

TTS module 124 may represent instructions forming a module that, when executed, cause processors 104 to perform automated TTS processing to produce audio book 125. Automated TTS processing may refer to one or more TTS algorithms (e.g., a generative adversarial network—GAN—model) that synthesizes LFTD 119 to produce audio book 125. Audio book 125 may include an annotated version of LFTD 119 (where such annotations facilitate near-real time application of TTS algorithms on computing device 100 and other computing device, such as an e-reader, smartphone, etc.) and possibly audio data output from TTS module 124 after synthesizing LFTD 119.

In operation, processors 104 may first invoke UI module 118, which may generate a UI (such as a graphical UI-GUI) by which to facilitate upload and/or delivery of LFTD 119. UI module 118 may interface with display 102 to present the GUI via display 102. In distributed computing system, UI module 118 may interface with communication unit 112 to provide the GUI to a client device (e.g., in a server, client distributed system). In either event, a human editor may interact with the GUI to provide LFTD 119 to computing device 100, which may store LFTD 119 to storage system 106.

Processors 104 may, responsive to receiving LFTD 119, next invoke preprocessing module 120, which may process LFTD 119 to generate synthesized documents 121. Preprocessing module 120 may shard LFTD 119 into chunks with a manageable size (e.g., N sentences) and wrap each chunk in markup text. Preprocessing module 120 may next analyze each wrapped chunk using text normalization to identify spans of words. Text normalization refers to a process of detecting multiword expressions over large chunks of text. Preprocessing module 120 may then parse the results of text normalization to generate sequential, non-overlapping spans of the input text (which in this example are the wrapped chunks). Preprocessing module 120 may then output the sequential, non-overlapping spans determined for each of the wrapped chunks as a respective one of synthesized documents 121.

Responsive to obtaining synthesized documents 121, processors 104 may invoke pronunciation model 122, which may process synthesized documents 121 to identify CW 123A that are predicted to be mispronounced during automated text-to-speech processing of LFTD 119. Pronunciation model 122 may include one or more different sub-models that perform pronunciation checking for various different scenarios.

For example, pronunciation module 122 may include a sub-model that identifies any text span (specified in synthesized documents 121) that has more than one possible pronunciation, specifying these text spans as CW 123A. In addition, pronunciation module 122 may include another sub-model that identifies any text span that has a single pronunciation, and the pronunciation is out of lexicon (e.g., for sounded-out words), specifying these text spans as CW 123A. Moreover, pronunciation module 122 may include a different sub-model that identifies any text spans that have a single pronunciation, and the pronunciation has multiple pronunciation parts (e.g., for spelled-out words and words within semiotic classes, such as emojis, emoticons, logos, brands, etc.).

In some instances, pronunciation module 122 may compute or otherwise determine a confidence score. That is, pronunciation module 122 may apply a learning model to the spans of words represented by synthesized documents 121 to determine the confidence score for each word span. Learning model may refer to a trained machine learning model that has been trained based on past pronunciation editing actions. The pronunciation editor GUI (shown in the examples of FIGS. 2A-3C) may provide direct feedback for determining the accuracy of the pronunciation for any given word. Using this feedback from the user (which may be anonymized and by default disabled, requiring explicit user consent to enable such feedback collection), various machine learning algorithms may train the underlying learning model to provide the confidence score. In any event, pronunciation module 122 may then determine, based on the confidence score, whether to add each word span to CW 123A. For example, for any word span that does not have a confidence score or has a confidence score below a threshold confidence score, pronunciation module 122 may add the word span to CW 123A.

Pronunciation module 122 may next filter CW 123A to remove one or more candidate words from CW 123A and obtain RCW 123B having fewer candidate words than CW 123A. Filtering of CW 123A may occur iteratively or concurrently according to a number of different sub-models.

For example, pronunciation module 122 may include a stop word sub-model that identifies the one or more candidate words of CW 123A that are stop word. Stop words refer to a collection of words that are very commonly used (in terms of an average number of appearances in any given text) such that these stop words convey very little useful information. Examples of stop words include “a,” “the,” “is,” “are,” etc. Although some of these stop words may have multiple pronunciations, typically TTS module 124 selects a given pronunciation (as determined by a selected automated TTS voice) for stop words consistently and thereby does not generally impact the audio book experience such that editing of stop words is warranted. As such, pronunciation module 122 may remove the one or more candidate words of CW 123A that are the stop words to obtain RCW 123B.

As another example, pronunciation module 122 may include a frequency count sub-model that identifies a candidate word count for each of CW 123A that indicates a number of times each candidate word appears in CW 123A. This count frequency sub-model may operate under similar assumptions as those set forth above with respect to the stop word sub-model in that frequently according to candidate words of CW 123A (those candidate words of CW 123A having a candidate word count greater than a candidate word count threshold) may convey less information. Pronunciation module 122 may then remove the one or more candidate words from CW 123A having an associated candidate word count that exceeds the candidate word count threshold.

As yet another example, pronunciation module 122 may include a homograph sub-model that identifies the one or more candidate words of CW 123A that are homographs not specified in a common homograph list. The homograph sub-model may dynamically update the common homograph list (e.g., via machine learning based on subsequent editing, editor/user input of vocal pronunciation, etc.). The term “homograph” refers to a word that have the same spelling but different pronunciations (e.g., “I will read this book” versus “I read this book already,” where read is the homograph). Pronunciation module 122 may remove the one or more candidate words of CW 123A that are identified as homographs not specified in the common homograph list (as only a subset of all homographs may need editing given that some homographs, for example, are stop words, etc.).

Pronunciation module 122 may also selectively apply the above noted learning model for computing a confidence score to CW 123A. In some instances (to reduce utilization of computing resources), pronunciation module 122 may selectively apply the learning model to determine a confidence score for a subset (which is not to be understood in the exact mathematical sense of including zero elements, but is used to denote less than all of the set) each of CW 123A. For example, pronunciation module 122 may, in some instances, apply the above noted learning model to CW 123A to determine the confidence score for each candidate word of CW 123A that are homographs Pronunciation module 122 may then remove, based on the confidence score for each candidate word of CW 123A that are homographs (e.g., by comparing the confidence score to a threshold confidence score), the one or more candidate words of CW 123A.

In addition, pronunciation module 122 may include a named entity sub-model that identifies the one or more candidate words of CW 123A that are named entities not specified in a common named entities list. The named entity sub-model may dynamically update the common named entity list (e.g., via machine learning based on subsequent editing, editor/user input of vocal pronunciation, etc.). Named entities refer to proper nouns, such as a name, a place, a company or business name, etc. Pronunciation module 122 may remove the one or more candidate words of CW 123A that are identified as named entities not specified in the common homograph list (e.g., as not all named entities are difficult to pronounce).

Pronunciation module 122 may further include a perplexity sub-model that identifies the one or more candidate words of CW 123A that have a high perplexity (in terms of pronunciation and as measured against a perplexity threshold). That is, perplexity sub-model may include a language model that determines a perplexity for each candidate word of CW 123A. Pronunciation module 122 may remove, based on the associated perplexity, the one or more candidate words of CW 123A. For example, pronunciation module 122 may compare each determined perplexity to a perplexity threshold and remove associated candidate words of CW 123A when the determined perplexity exceeds the perplexity threshold.

In this respect, pronunciation module 122 may represent a model of models that applies a sequence (but possibly also currently or at least overlapping) a number of different sub-models to filter CW 123A to produce RCW 123B. As noted above, one or more of the sub-models may be adaptive in that the sub-models may employ machine learning to continually adapt to changing text norms and editor feedback (which may even be tailored to individual editor preferences). In some examples, the sub-models may include binary classification models

After generating RCW 123B through application of the sub-models, pronunciation module 122 may annotate LFTD 119 to obtain an annotated text document that identifies RCW 123B, where the annotated text document may be represented in the example of FIG. 1 by audio book 125 Pronunciation module 122 may annotate LFTD 119 by populating each of RCW 123B occurrence with the start position and end position of the respective candidate word in LFTD 119, linking each of RCW 123B back to LFTD 119. Pronunciation module 122 may also invoke TTS module 124 to provide each of RCW 123B with one or more pronunciation candidates which may be ordered according to the respective confidence score. Pronunciation module 122 may also associate each of the one or more pronunciations to the respective location in LFTD 119. In this way, pronunciation module 122 may automatically form audio book 125 that includes an annotated version of LFTD 119.

Pronunciation module 122 may not edit the underlying text of LFTD 119, but merely add annotation (possibly via markup text) that facilitates better pronunciation by automated TTS algorithms. By avoiding editing the text of LFTD 119, pronunciation module 122 allows for reading of the actual text, but should the reader prefer an audible book experience as would be read by a narrator, the automated TTS algorithms may utilize the annotations to make editor informed decisions regarding the correct pronunciation that would otherwise be up to random change due to the programmers of whatever automated TTS algorithms are employed. As such, various aspects of the techniques allow computing devices a guided pronunciation experience in which human editors utilize a streamlined (due to filtering) pronunciation editor to generate the annotations that result in a guided TTS that generally improves upon pronunciation compared to unguided TTS synthesis.

After generating audio book 125. processors 104 may next invoke UI module 118, which may generate a GUI that outputs at least a portion of the annotated text document included within audio book 125 that identifies at least one candidate word of RCW 123B. UI module 118 may output the GUI via display 102 and/or communication units 112 (again, e.g., in the context of distributed server client systems). Via the GUI, the human editor may interact with computer device 100 to edit the pronunciation via a visual representation of the pronunciation checker, possibly entering verbal narration for preferred pronunciation of RCW 123B as described in more detail below.

In this respect, filtering of candidate words may reduce time spent on inconsequential mispronunciations and focus attention on difficult to pronounce words (e.g., proper nouns, vague words in terms of, as an example, inflection, etc.), intentionally misspelled words. words with the same spelling but different pronunciations (which again are referred to as homographs), and the like. As such, human editors may focus on candidate words that are likely to significantly detract from the audio experience. In some instances, the editor may interact with computing device 100 to enter a verbal pronunciation that the computing device then uses to correct the automated text-to-speech pronunciation (e.g., selecting a pronunciation that best matches the entered verbal pronunciations).

In this way, various aspects of the techniques may thereby facilitate more efficient execution of computing device 100 in terms of computing resources (e.g., processor cycles, memory usage, memory bus bandwidth usage, and the accompanying power consumption) while also promoting a better user experience for editing potential mispronunciations by automated text-to-speech algorithms. The techniques may reduce utilization of computing resources by filtering candidate words to enable editors to focus on words that are difficult to pronounce, which results in less processing during the editing process and thereby reduces utilization of the computing resources. Moreover, the techniques may provide a better editing experience by focusing attention on words that are difficult to pronounce while also improving pronunciation of candidate words by automated text-to-speech algorithms (which produces a better quality audio book experience compared to automated text-to-speech algorithms that do not facilitate pronunciation review and adjustment).

FIGS. 2A-2C are diagrams illustrating example user interfaces with which a human editor may interact to facilitate efficient pronunciation checking for long form text documents in accordance with various aspects of the techniques described in this disclosure. In the example of FIG. 2A, a user interface 200A may represent an example of an interactive user interface (e.g., an interactive graphical user interface—iGUI) generated and output by UI module 118.

User interface 200A may represent an interactive user interface with which a user (e.g., a human editor) may interact to edit pronunciation by an automated narrator. User interface 200A may include an e-book overview pane 202 including an audiobook text selector 204 among other selectors by which to view book information (such as author, publisher, publication year, etc.), contents (e.g., a table of contents), pricing information, a summary of the e-book (such as would appear on an inside cover slip or back of the book), and event history. In the example of FIG. 2A, the user has selected audiobook text selector 204.

Responsive to selecting audiobook text selector 204, user interface 200A presents sections pane 206, audiobook text pane 208, automated narrator voice selector 210, save button 212, and publish button 214. Sections pane 206 may present a list of sections (resembling a table of contents). In section pane 206, user interface 200A has presented a number of lined through sections (e.g., Cover, Title Page, Copyright. Contents, Endpaper Photographs. Introduction to the Paperbac . . . ) along with unlined through sections (e.g., Preface, Becoming Me. Chapter 1, etc.). UI module 118 may interface with various modules 120-124 to identify which sections should be eliminated from audio book 125. Preprocessing module 120 may be configured to identify which sections should be eliminated from audio narration, passing a list of sections to UI module 118 that should be eliminated from audio narration. UI module 118 may then generate sections pane 206 based on the list of eliminated sections.

Audiobook text pane 208 may reproduce the text for audio book 125 based on LFTD 119. Audiobook text pane 208 may include an exclude toggle 216 and a play button 218. Exclude toggle 216 may toggle exclusion of the section or sub-section (i.e., Chapter 1 sub-section in the Becoming Me section in the example of FIG. 2A) in audio book 125. Play button 218 may begin playback of the audiobook text shown in audiobook text pane 208 using a selected automated narrator voice. The user may interact with automated narrator voice selector 210 to select between different auto narrator voices (which may have a certain gender and accent). The user may interact with audiobook text pane 208 to edit the underlying audiobook text, selecting save button 212 to save the edits or publish button 214 when editing is complete to publish audio book 125 (e.g., to an online store, such as an online audio book store).

In the example of FIG. 2B, a user interface 200B may represent user interface 200A after the user has selected word 220 (e.g., a so-called “right click” of a mouse in which the user clicks the right mouse button while hovering the cursor over word 220). Word 220 may represent an example of RCWs 123B, which is a proper entity identified by the proper entity sub-model of pronunciation module 122. Responsive to selecting word 220, UI module 118 may update user interface 200A to include edit pane 230 (thereby transitioning user interface 200A to user interface 200B).

Edit pane 230 includes an edit pronunciation button 232 and a play word button 234. Edit pronunciation button 232 may allow the user to edit the pronunciation of word 220, while play word button 234 may cause UI module 118 to present the audio data provided by TTS module 124 in audio book 125 for word 220 (using the selected automated narrator voice).

Referring next to the example of FIG. 2C, a user interface 200C represents an example of user interface 200B after the user selects edit pronunciation button 232. User interface 200C still displays audiobook text pane 208, but reveals an edit pronunciation pane 240 that includes a play/pause button 242 for initiating playback of individual RCW 123B shown in list 244.

In the example of FIG. 2C, the user has selected entry 246 in list 244 of RCW 123B that includes the word “mavjee.” which represents a word that is out of the lexicon. The user has also selected play/pause button 242 causing UI module 118 to playback the word span in which entry 246 appears. UI module 118 may highlight the word span in audiobook text pane 208, which is shown as highlight 260.

In this respect, UI module 118 may receive an input (e.g., selection of play/pause button 242) via interactive user interface 200C selecting the at least one candidate word (as represented by entry 246) of RCW 123B. UI module 118 may obtain, responsive to this input, pronunciation audio data representative of a verbal pronunciation of the at least one candidate word (as provided by TTS module 124 and linked by pronunciation module 122 as described above) of RCW 123B. UI module 118 may then output the pronunciation audio data for playback via a speaker (such as a loudspeaker, an internal speaker, headphone speakers, etc.).

In any event, the user may listen to the pronunciation of entry 246 in the context of the word span highlighted as highlight 260 in order to decide whether the pronunciation by automated narrator is suitable in the context of the highlighted word span. If the user decides that the pronunciation is not suitable, the user may edit the pronunciation. That is, entry 246 includes an edit button 248 and a status 250A along with a number of occurrences of the word “mavjee” in LFTD 119 (as determined by pronunciation module 122). The user may select edit button 248 to edit the pronunciation (by, for example, providing a phonetic spelling of the word “mavjee,” providing a verbal pronunciation, or the like). Status 250A may indicate that entry 246 is currently being played back. Once edited, status 250A may shift to status 250B (shown with respect to another entry, but such status 250B is illustrative of a shift in status that may occur with respect to status 250A of entry 246).

FIGS. 3A-3C are additional diagrams illustrating example user interfaces with which the human editor may interact to facilitate efficient pronunciation checking for long form text documents in accordance with various aspects of the techniques described in this disclosure. In the example of FIG. 3A, a user interface 300A may represent another example of an interactive user interface generated and output by UI module 118. User interface 300A may be similar to user interface 200C shown in the example of FIG. 2C in that user interface 300A includes a section pane 306, an audiobook text pane 308, an automated narrator voice selector 310, a save button 312, and an edit pronunciation pane 340A.

Panes 306, 308, and 340A may be similar, if not substantially similar, to respective panes 206, 208, and 240. However, section pane 306 does not include lined off sections, but rather omits sections that are not subject to automated TTS narration. Audiobook text pane 308 is substantially similar to audiobook text pane 208, and as such audiobook text pane 308 also includes an exclude toggle 316 that functions similar to exclude toggle 216 and a play button 318 that functions similar to play button 218 (shown in the example of FIG. 2A).

Edit pronunciation pane 340A is similar to edit pronunciation pane 240, but differs in that edit pronunciation pane 340A includes a review of all potential pronunciation errors. Edit pronunciation pane 340A may, as a result, be referred to as review pronunciation pane 340A Review pronunciation pane 340A includes a review entry 370 that specifies a number of RCW 123B that are predicted as requiring review (e.g., based on the confidence score being below a threshold confidence score).

As further shown in the example of FIG. 3A, user interface 300A includes an automated narrator voice selector 310 that function similar to, if not the same as, automated narrator voice selector 210. User interface 300A also includes a save button 312 that functions similar to save button 212. User interface 300A further includes a create audio file button 314 that may be similar to publish button 314 in that audio book 125 is created, but differs in that audio book 125 is not immediately published to an online store. Instead, selection of create audio file button 314 may result in generation of audio book 125 without immediate publication to the online store.

In the example of FIG. 3B, review pronunciation pane 340B represents the result of the user selecting review entry 370 of review pronunciation pane 340A. As such. UI module 118 may transition from review pronunciation pane 340A to review pronunciation pane 340B upon receiving the selection of review entry 370.

Review pronunciation pane 340B may include tabs 380A and 380B. The line under tab 380A indicates that the user has selected or UI module 118 has defaulted selection of tab 380A. Tab 380B, when selected, may result in UI module 118 populated review pane 340B with all specific review entries that have been previously reviewed by the user. In response to the selection (default or otherwise) of tab 380A, UI module 118 bas populated review pronunciation pane 340B with specific review entries 382A-382D (“specific review entries 382”). Each of specific review entries 382 may represent a particular pronunciation error. displaying a number of instances of each error, a play button 384, an accept for all button 386, and a review button 388 (each of which is denoted for ease of illustration purposes only with respect to specific review entry 382A).

Play button 384 may configure UI module 118 to provide the audio data associated with one or more instances of specific review entry 382A for playback via a speaker. Accept for all button 386 may configure UI module 118 to accept the current pronunciation (e.g., the existing audio data) for each of the instances of specific review entry 382A (i.e., all 12 instances in the example of specific review entry 382A). Review button 388 may configure UI module 118 to transition from review pronunciation pane 340B to a review pronunciation pane 340C (which is shown in the example of FIG. 3C) that facilitates review of the pronunciation for associated specific review entry 382. In this respect, review button 388 may enable individual review (or in other words, case-by-case review) of a specific instance of the mispronounced word.

In the example of FIG. 3C, a user interface 300C is similar to user interface 300A except that user interface 300C includes review pronunciation pane 340C showing the result of the user selecting specific review entry 382A shown in review pronunciation pane 340B of FIG. 3B. Review pronunciation pane 340C includes a back button 390, a play button 384, an accept button 391, a phonetic text entry field 392, a record button 393, a play button 394, an instance apply button 395, an apply to all instances button 396, and an instance selector 398.

Back button 390 may configure UI module 118 to return from review pronunciation pane 340C back to review pronunciation pane 340B shown in the example of FIG. 3B. Play button 384 may configure UI module 118 to output audio data associated with the specific instance under review for playback via a speaker. Instance apply button 395 may configure UI module 118 to apply the currently selected audio data to the specific instance under review. Phonetic text entry field 392 may allow the user to type a phonetic text phrase that results in a different pronunciation, which the user may listen to by selecting play button 394. As such, phonetic text entry field 392 may configure UI module 118 to provide any entered text to TTS module 124 upon selection of play button 394, which TTS module 124 may synthesize into audio data. UI module 118 may then output the synthesized audio data for playback via the speaker.

Likewise, record button 393 may allow the user to speak the pronunciation of the particular instance, thereby providing pronunciation audio data back to UI module 118. UI module 118 may provide the pronunciation audio data to pronunciation module 122, which may use the pronunciation audio data to select one of the available pronunciations synthesized by TTS module 124 and associated with any one of the pronunciations for any of the instances. Selection of play button 394 after providing pronunciation audio data may configure UI module 118 to retrieve the pronunciation selected based on the pronunciation audio data and output this pronunciation for playback by the speaker.

In this respect, UI module 118 may receive an input via the interactive user interface selecting the at least one candidate word of RCW 123B (i.e., “Reeaallyy” in this example). which was selected via input of a selection of specific review entry 382A. UI module 118 may also receive a verbal pronunciation (in response to selection of record button 393) of the candidate word of RCW 123B. UI module 118, interfacing with pronunciation module 122, may identify, based on the verbal pronunciation, a potential pronunciation from a number of different potential pronunciations. Pronunciation module 122 may then associate the potential pronunciation to the at least one candidate word of RCW 123B.

Apply button 395 may configure UI module 118 to associate the current pronunciation with the particular instance of the candidate word. Apply to all instances 396 may configure UI module 118 to associate the current pronunciation for the selected instance to all instances of the candidate word (which is, again, “Reeaallyy” in this example). Instance selector 398 may configure UI module 118 to switch between different instances of the candidate word, thereby allowing the user to select different instances for review.

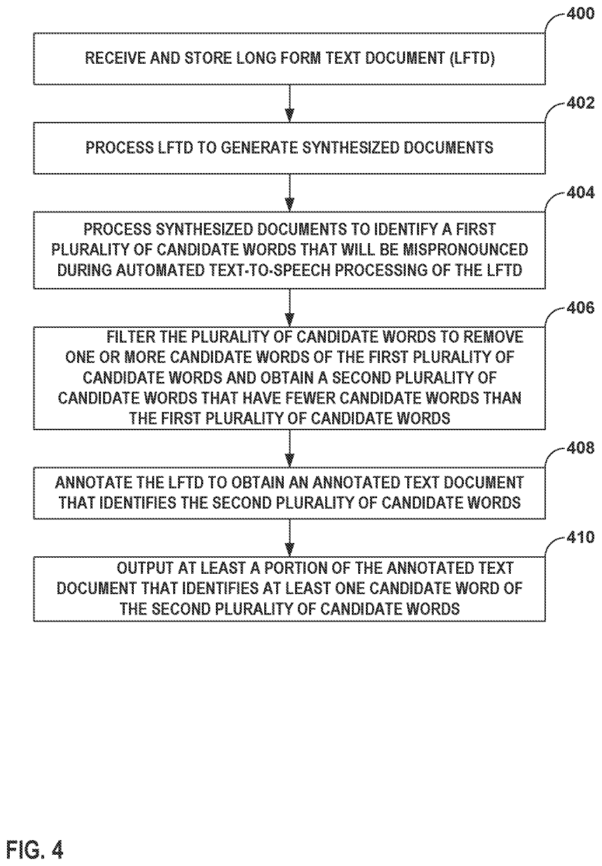

FIG. 4 is a flowchart illustrating example operation of an example computing device configured to perform pronunciation editing for automated text-to-speech algorithms in accordance with one or more aspects of the present disclosure. Processors 104 may first invoke UI module 118, which may generate a UI (such as a graphical UI-GUI) by which to facilitate upload and/or delivery of LFTD 119. UI module 118 may interface with display 102 to present the GUI via display 102. In distributed computing system, UI module 118 may interface with communication unit 112 to provide the GUI to a client device (e.g., in a server, client distributed system). In either event, a human editor may interact with the GUI to provide LFTD 119 to computing device 100, which may receive and store LFTD 119 to storage system 106 (400).

Processors 104 may, responsive to receiving LFTD 119, next invoke preprocessing module 120, which may process LFTD 119 to generate synthesized documents 121 (402). Preprocessing module 120 may shard LFTD 119 into chunks with a manageable size (e.g. N sentences) and wrap each chunk in markup text. Preprocessing module 120 may next analyze each wrapped chunk using text normalization to identify spans of words. Text normalization refers to a process of detecting multiword expressions over large chunks of text. Preprocessing module 120 may then parse the results of text normalization to generate sequential, non-overlapping spans of the input text (which in this example are the wrapped chunks). Preprocessing module 120 may then output the sequential, non-overlapping spans determined for each of the wrapped chunks as a respective one of synthesized documents 121.

Responsive to obtaining synthesized documents 121, processors 104 may next invoke pronunciation model 122, which may process synthesized documents 121 to identify CW 123A (representative of a first plurality of candidate words) that are predicted to be mispronounced during automated text-to-speech processing of LFTD 119 (404). Pronunciation module 122 may next filter CW 123A to remove one or more candidate words from CW 123A and obtain RCW 123B (representative of a second plurality of candidate words) having fewer candidate words than CW 123A (406). After generating RCW 123B through application of the above noted sub-models, pronunciation module 122 may annotate LFTD 119 to obtain an annotated text document that identifies RCW 123B, where the annotated text document may be represented in the example of FIG. 1 by audio book 125 (408).

Upon generating audio book 125, processors 104 may next invoke UI module 118, which may generate a GUI that outputs at least a portion of the annotated text document included within audio book 125 that identifies at least one candidate word of RCW 123B (410). UI module 118 may output the GUI via display 102 and/or communication units 112 (again, e.g., in the context of distributed server client systems). Via the GUI, the human editor may interact with computer device 100 to edit the pronunciation via a visual representation of the pronunciation checker, possibly entering verbal narration for preferred pronunciation of RCW 123B as described in more detail below.

In this respect, various aspects of the techniques enable the following examples.

Example 1. A method comprising: processing words in a text document to identify a first plurality of candidate words that are predicted to be mispronounced during automated text-to-speech processing of the text document; filtering the first plurality of candidate words to remove one or more candidate words of the first plurality of candidate words and obtain a second plurality of candidate words that have fewer candidate words than the first plurality of candidate words; annotating the text document to obtain an annotated text document that identifies the second plurality of candidate words; and outputting at least a portion of the annotated text document that identifies at least one candidate word of the second plurality of candidate words.

Example 2. The method of example 1, wherein filtering the first plurality of candidate words includes: identifying the one or more candidate words of the first plurality of candidate words that is a stop word, and removing the one or more candidate words of the first plurality of candidate words that are the stop words to obtain the second plurality of candidate words.

Example 3. The method of any combination of examples 1 and 2, wherein filtering the first plurality of candidate words includes: identifying a candidate word count for the first plurality of candidate words that indicates a number of times each candidate word appears in the first plurality of candidate words; and removing the one or more candidate words from the first plurality of candidate words having the candidate word count that exceeds a threshold.

Example 4. The method of any combination of examples 1-3, wherein filtering the first plurality of candidate words includes: identifying the one or more candidate words of the first plurality of candidate words that are homographs not specified in a common homograph list; and removing the one or more candidate words of the first plurality of candidate words that are identified as homographs not specified in the common homograph list.

Example 5. The method of any combination of examples 1-4, wherein filtering the first plurality of candidate words includes: identifying the one or more candidate words of the first plurality of candidate words that are named entities specified in a common named entities list; and removing the one or more candidate words of the first plurality of candidate words that are identified as named entities specified in the common named entities list.

Example 6. The method of any combination of examples 1-5, wherein filtering the first plurality of candidate words includes: applying a language model to the first plurality of candidate words to determine a perplexity of each candidate word of the first plurality of candidate words; and removing, based on the perplexity of each candidate word of the first plurality of candidate words, the one or more candidate words of the first plurality of candidate words.

Example 7. The method of any combination of examples 1-6, wherein filtering the first plurality of candidate words includes: applying a learning model to the first plurality of candidate words to determine a confidence score for each candidate word of the first plurality of candidate words that are homographs; and removing, based on the confidence score each candidate word of the first plurality of candidate words that are homographs, the one or more candidate words of the first plurality of candidate words.

Example 8. The method of any combination of examples 1-7, wherein outputting at least the portion of the annotated text document comprises displaying at least the portion of the annotated text document via an interactive user interface, and wherein the method further comprises: receiving an input via the interactive user interface selecting the at least one candidate word of the second plurality of candidate words; obtaining, responsive to receiving the input, pronunciation audio data representative of a verbal pronunciation of the at least one candidate word of the second plurality of candidate words; and outputting the pronunciation audio data for playback via a speaker.

Example 9. The method of any combination of examples 1-8, wherein outputting at least the portion of the annotated text document comprises displaying at least the portion of the annotated text document via an interactive user interface, and wherein the method further comprises: receiving an input via the interactive user interface selecting the at least one candidate word of the second plurality of candidate words; receiving a verbal pronunciation of the at least one candidate word of the second plurality of candidate words; identifying, based on the verbal pronunciation, a potential pronunciation from a plurality of potential pronunciations; and associating the potential pronunciation to the at least one candidate word of the second plurality of candidate words.

Example 10. A computing device comprising: a memory configured to store a text document; one or more processors configured to: process words in the text document to identify a first plurality of candidate words that are predicted to be mispronounced during automated text-to-speech processing of the text document; filter the first plurality of candidate words to remove one or more candidate words of the first plurality of candidate words and obtain a second plurality of candidate words that have fewer candidate words than the first plurality of candidate words; annotate the text document to obtain an annotated text document that identifies the second plurality of candidate words; and output at least a portion of the annotated text document that identifies at least one candidate word of the second plurality of candidate words.

Example 11. The computing device of example 10, wherein the one or more processors are, when configured to filter the first plurality of candidate words, configured to: identify the one or more candidate words of the first plurality of candidate words that is a stop word; and remove the one or more candidate words of the first plurality of candidate words that are the stop words to obtain the second plurality of candidate words.

Example 12. The computing device of any combination of examples 10 and 11, wherein the one or more processors are, when configured to filter the first plurality of candidate words, configured to: identify a candidate word count for the first plurality of candidate words that indicates a number of times each candidate word appears in the first plurality of candidate words; and remove the one or more candidate words from the first plurality of candidate words having the candidate word count that exceeds a threshold.

Example 13. The computing device of any combination of examples 10-12, wherein the one or more processors are, when configured to filter the first plurality of candidate words, configured to: identify the one or more candidate words of the first plurality of candidate words that are homographs not specified in a common homograph list; and remove the one or more candidate words of the first plurality of candidate words that are identified as homographs not specified in the common homograph list.

Example 14 The computing device of any combination of examples 10-13, wherein the one or more processors are, when configured to filter the first plurality of candidate words, configured to: identify the one or more candidate words of the first plurality of candidate words that are named entities specified in a common named entities list; and remove the one or more candidate words of the first plurality of candidate words that are identified as named entities specified in the common named entities list.

Example 15. The computing device of any combination of examples 10-14, wherein the one or more processors are, when configured to filter the first plurality of candidate words, configured to: apply a language model to the first plurality of candidate words to determine a perplexity of each candidate word of the first plurality of candidate words: remove, based on the perplexity of each candidate word of the first plurality of candidate words, the one or more candidate words of the first plurality of candidate words.

Example 16. The computing device of any combination of examples 10-15, wherein the one or more processors are, when configured to filter the first plurality of candidate words, configured to: apply a learning model to the first plurality of candidate words to determine a confidence score for each candidate word of the first plurality of candidate words that are homographs; remove, based on the confidence score each candidate word of the first plurality of candidate words that are homographs, the one or more candidate words of the first plurality of candidate words.

Example 17. The computing device of any combination of examples 10-16, wherein the one or more processors are, when configured to output at least the portion of the annotated text document, configured to display at least the portion of the annotated text document via an interactive user interface, and wherein the one or more processors are further configured to: receive an input via the interactive user interface selecting the at least one candidate word of the second plurality of candidate words; obtain, responsive to receiving the input, pronunciation audio data representative of a verbal pronunciation of the at least one candidate word of the second plurality of candidate words; and output the pronunciation audio data for playback via a speaker.

Example 18. The computing device of any combination of examples 10-17, wherein the one or more processors are, when configured to output at least the portion of the annotated text document, configured to display at least the portion of the annotated text document via an interactive user interface, and wherein the one or more processors are further configured to, receive an input via the interactive user interface selecting the at least one candidate word of the second plurality of candidate words; receive a verbal pronunciation of the at least one candidate word of the second plurality of candidate words; identify, based on the verbal pronunciation, a potential pronunciation from a plurality of potential pronunciations; and associate the potential pronunciation to the at least one candidate word of the second plurality of candidate words.

Example 19. A non-transitory computer-readable storage medium having instructions stored thereon that, when executed, cause one or more processors to, process words in a text document to identify a first plurality of candidate words that are predicted to be mispronounced during automated text-to-speech processing of the text document; filter the first plurality of candidate words to remove one or more candidate words of the first plurality of candidate words and obtain a second plurality of candidate words that have fewer candidate words than the first plurality of candidate words; annotate the text document to obtain an annotated text document that identifies the second plurality of candidate words; and output at least a portion of the annotated text document that identifies at least one candidate word of the second plurality of candidate words.

Example 20 The non-transitory computer-readable storage medium of example 19, wherein the instructions that, when executed, cause the one or more processor to filter the plurality of candidate words includes instructions that, when executed, cause the one or more processors to: identify the one or more candidate words of the first plurality of candidate words that are homographs not specified in a common homograph list; and remove the one or more candidate words of the first plurality of candidate words that are identified as homographs not specified in the common homograph list.

Example 21. A non-transitory computer-readable storage medium having instructions stored thereon that, when executed, cause one or more processors to perform the method recited by any of combination of examples 1-9.

Example 22. An apparatus comprising means for performing each step of the method recited by any combination of examples 1-9.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs). general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
processing words in a text document to identify a first plurality of candidate words that are predicted to be mispronounced during automated text-to-speech processing of the text document;
filtering the first plurality of candidate words to remove one or more candidate words of the first plurality of candidate words and obtain a second plurality of candidate words that have fewer candidate words than the first plurality of candidate words;
annotating the text document to obtain an annotated text document that identifies the second plurality of candidate words; and
outputting at least a portion of the annotated text document that identifies at least one candidate word of the second plurality of candidate words.

2. The method of claim 1, wherein filtering the first plurality of candidate words includes:
identifying the one or more candidate words of the first plurality of candidate words that is a stop word; and
removing the one or more candidate words of the first plurality of candidate words that are the stop words to obtain the second plurality of candidate words.

3. The method of claim 1, wherein filtering the first plurality of candidate words includes:
identifying a candidate word count for the first plurality of candidate words that indicates a number of times each candidate word appears in the first plurality of candidate words; and
removing the one or more candidate words from the first plurality of candidate words having the candidate word count that exceeds a threshold.

4. The method of claim 1, wherein filtering the first plurality of candidate words includes:
identifying the one or more candidate words of the first plurality of candidate words that are homographs not specified in a common homograph list; and
removing the one or more candidate words of the first plurality of candidate words that are identified as homographs not specified in the common homograph list.

5. The method of claim 1, wherein filtering the first plurality of candidate words includes:
identifying the one or more candidate words of the first plurality of candidate words that are named entities specified in a common named entities list; and
removing the one or more candidate words of the first plurality of candidate words that are identified as named entities specified in the common named entities list.

6. The method of claim 1, wherein filtering the first plurality of candidate words includes:
applying a language model to the first plurality of candidate words to determine a perplexity of each candidate word of the first plurality of candidate words; and
removing, based on the perplexity of each candidate word of the first plurality of candidate words, the one or more candidate words of the first plurality of candidate words.

7. The method of claim 1, wherein filtering the first plurality of candidate words includes:
applying a learning model to the first plurality of candidate words to determine a confidence score for each candidate word of the first plurality of candidate words that are homographs; and
removing, based on the confidence score for each candidate word of the first plurality of candidate words that are homographs, the one or more candidate words of the first plurality of candidate words.

8. The method of claim 1,
wherein outputting at least the portion of the annotated text document comprises displaying at least the portion of the annotated text document via an interactive user interface, and
wherein the method further comprises:
receiving an input via the interactive user interface selecting the at least one candidate word of the second plurality of candidate words;
obtaining, responsive to receiving the input, pronunciation audio data representative of a verbal pronunciation of the at least one candidate word of the second plurality of candidate words; and
outputting the pronunciation audio data for playback via a speaker.

9. The method of claim 1,
wherein outputting at least the portion of the annotated text document comprises displaying at least the portion of the annotated text document via an interactive user interface, and
wherein the method further comprises:
receiving an input via the interactive user interface selecting the at least one candidate word of the second plurality of candidate words;
receiving a verbal pronunciation of the at least one candidate word of the second plurality of candidate words;
identifying, based on the verbal pronunciation, a potential pronunciation from a plurality of potential pronunciations; and
associating the potential pronunciation to the at least one candidate word of the second plurality of candidate words.

10. A computing device comprising:
a memory configured to store a text document;
one or more processors configured to:
process words in the text document to identify a first plurality of candidate words are predicted to be mispronounced during automated text-to-speech processing of the text document:
filter the first plurality of candidate words to remove one or more candidate words of the first plurality of candidate words and obtain a second plurality of candidate words that have fewer candidate words than the first plurality of candidate words;
annotate the text document to obtain an annotated text document that identifies the second plurality of candidate words; and
output at least a portion of the annotated text document that identifies at least one candidate word of the second plurality of candidate words.

11. The computing device of claim 10, wherein the one or more processors are, when configured to filter the first plurality of candidate words, configured to:
identify the one or more candidate words of the first plurality of candidate words that is a stop word; and
remove the one or more candidate words of the first plurality of candidate words that are the stop words to obtain the second plurality of candidate words.

12. The computing device of claim 10, wherein the one or more processors are, when configured to filter the first plurality of candidate words, configured to:
identify a candidate word count for the first plurality of candidate words that indicates a number of times each candidate word appears in the first plurality of candidate words; and
remove the one or more candidate words from the first plurality of candidate words having the candidate word count that exceeds a threshold.

13. The computing device of claim 10, wherein the one or more processors are, when configured to filter the first plurality of candidate words, configured to:
identify the one or more candidate words of the first plurality of candidate words that are homographs not specified in a common homograph list; and
remove the one or more candidate words of the first plurality of candidate words that are identified as homographs not specified in the common homograph list.

14. The computing device of claim 10, wherein the one or more processors are, when configured to filter the first plurality of candidate words, configured to:
identify the one or more candidate words of the first plurality of candidate words that are named entities specified in a common named entities list; and
remove the one or more candidate words of the first plurality of candidate words that are identified as named entities specified in the common named entities list.

15. The computing device of claim 10, wherein the one or more processors are, when configured to filter the first plurality of candidate words, configured to:
apply a language model to the first plurality of candidate words to determine a perplexity of each candidate word of the first plurality of candidate words; and
remove, based on the perplexity of each candidate word of the first plurality of candidate words, the one or more candidate words of the first plurality of candidate words.

16. The computing device of claim 10, wherein the one or more processors are, when configured to filter the first plurality of candidate words, configured to:
apply a learning model to the first plurality of candidate words to determine a confidence score for each candidate word of the first plurality of candidate words that are homographs; and
remove, based on the confidence score for each candidate word of the first plurality of candidate words that are homographs, the one or more candidate words of the first plurality of candidate words.

17. The computing device of claim 10,
wherein the one or more processors are, when configured to output at least the portion of the annotated text document, configured to display at least the portion of the annotated text document via an interactive user interface, and
wherein the one or more processors are further configured to:
receive an input via the interactive user interface selecting the at least one candidate word of the second plurality of candidate words;
obtain, responsive to receiving the input, pronunciation audio data representative of a verbal pronunciation of the at least one candidate word of the second plurality of candidate words; and
output the pronunciation audio data for playback via a speaker.

18. The computing device of claim 10,
wherein the one or more processors are, when configured to output at least the portion of the annotated text document, configured to display at least the portion of the annotated text document via an interactive user interface, and
wherein the one or more processors are further configured to:
receive an input via the interactive user interface selecting the at least one candidate word of the second plurality of candidate words;
receive a verbal pronunciation of the at least one candidate word of the second plurality of candidate words;
identify, based on the verbal pronunciation, a potential pronunciation from a plurality of potential pronunciations; and
associate the potential pronunciation to the at least one candidate word of the second plurality of candidate words.

19. A non-transitory computer-readable storage medium having instructions stored thereon that, when executed, cause one or more processors to:
process words in a text document to identify a first plurality of candidate words that are predicted to be mispronounced during automated text-to-speech processing of the text document;
filter the first plurality of candidate words to remove one or more candidate words of the first plurality of candidate words and obtain a second plurality of candidate words that have fewer candidate words than the first plurality of candidate words;
annotate the text document to obtain an annotated text document that identifies the second plurality of candidate words; and
output at least a portion of the annotated text document that identifies at least one candidate word of the second plurality of candidate words.

20. The non-transitory computer-readable storage medium of claim 19, wherein the instructions that, when executed, cause the one or more processor to filter the plurality of candidate words includes instructions that, when executed, cause the one or more processors to:
identify the one or more candidate words of the first plurality of candidate words that are homographs not specified in a common homograph list; and
remove the one or more candidate words of the first plurality of candidate words that are identified as homographs not specified in the common homograph list.
